(19) United States
(12) Patent Application Publication
(10) Pub. No.: US 2023/0376869 A1
(43) Pub. Date: Nov. 23, 2023

(54) CONFIGURING WORKSPACES BASED ON KNOWLEDGE GRID ADJACENCY OPTIMIZATION

(71) Applicant: INTERNATIONAL BUSINESS MACHINES CORPORATION, Armonk, NY (US)

(72) Inventors: Liyan Fang, Sunnyvale, CA (US); Mansoor Ahmed, BANGALORE (IN); Sattwati Kundu, Bangalore (IN); Nair Raghunath Eledath, Bangalore (IN)

(21) Appl. No.: 17/748,297

(22) Filed: May 19, 2022

(51) Int. Cl. G06Q 10/06

(52) U.S. Cl. CPC G06Q 10/06313

(57) ABSTRACT

An approach for optimizing workspace allocation. The approach receives a request for workspace seats based on an associated workspace floor plan. The approach annotates the floor plan based on occupied and unoccupied seats and their owning organizational component, non-movable spaces, and walkways. The approach overlays the floorplan with a grid, creates groups based on seat clusters, and annotates the groups based on owning component. The approach determines an optimal assignment of seats based on predefined constraints, vacant seat locations and distances between component groups and vacant seats based on a distance calculation.

### TECHNICAL FIELD

The present invention relates generally to workspace configuration, and specifically, to configure workspaces based on optimizing adjacency using a knowledge grid.

### BACKGROUND

Today's dynamic workplace requires a space manager application capable of accommodating/reconfiguring spaces and/or seating to align with changing business requirements such as, but not limited to, fulfilling additional seat requirements within existing floors, reconfiguring floors based on team downsizing, etc. In another example, different business groups typically want their group to collocate in a building to increase productivity and communication. However, certain business groups cannot or should not collocate, e.g., a Human Resources Department and Legal Department may require isolation from each other.

Currently, workspaces are configured and reconfigured in an attempt to determine a better arrangement. Considerable manual experimentation and iterations are necessary to arrive at what appears to be the best arrangement based on the tested configurations. There is a need to provide recommendations to the space manager application to reconfigure/realign workspaces in a building space footprint, while minimizing seat movements and maintaining adjacency requirements.

### BRIEF SUMMARY

According to an embodiment of the present invention, a computer-implemented method for optimizing workspace allocation, the computer-implemented method comprising: receiving, by one or more processors, a request, from a first component of an organization, to allocate additional workspaces in a space associated with a floor plan; annotating, by the one or more processors, seats in the floor plan as occupied or unoccupied; annotating, by the one or more processors, seats in the floor plan based on owning components of the organization; annotating, by the one or more processors, non-moveable spaces in the floor plan; annotating, by the one or more processors, walkways in the floor plan; overlaying, by the one or more processors, the floor plan with a grid of predefined cell dimension; creating, by the one or more processors, groups based on clusters of seat locations; annotating, by the one or more processors, the groups based on an owning component with a majority of seats in a group; determining, by the one or more processors, if the first component owns sufficient unoccupied seat locations to satisfy the request; responsive to the first component owning sufficient unoccupied seat locations, allocating, by the one or more processors, the additional workspaces to the first component from the unoccupied seat locations owned by the first component; responsive to the first component not owning sufficient unoccupied seat locations, executing, by the one or more processors, the actions comprising: determining, by the one or more processors, if vacant seats exist in a closest first group owned by a second component; responsive to vacant seats existing, allocating, by the one or more processors, the vacant seats to the first component; and responsive to vacant seats not existing, calculating, by the one or more processors, if a lower cost is associated with relocating occupied seats associated with the second component to vacant seats in a second group and allocating, by the one or more processors, the previously occupied seats to the first component, or allocating, by the one or more processors, vacant seats in the second group to the first component, and allocating, by the one or more processors, seats based on a lowest cost.

According to an embodiment of the present invention, a computer program product for optimizing workspace allocation, the computer program product comprising: one or more non-transitory computer readable storage media and program instructions stored on the one or more non-transitory computer readable storage media, the program instructions comprising: program instructions to receive a request, from a first component of an organization, to allocate additional workspaces in a space associated with a floor plan; program instructions to annotate seats in the floor plan as occupied or unoccupied; program instructions to annotate seats in the floor plan based on owning components of the organization; program instructions to annotate non-moveable spaces in the floor plan; program instructions to annotate walkways in the floor plan; program instructions to overlay the floor plan with a grid of predefined cell dimension; program instructions to create groups based on clusters of seat locations; program instructions to annotate the groups based on an owning component with a majority of seats in a group; program instructions to determine if the first component owns sufficient unoccupied seat locations to satisfy the request; responsive to the first component owning sufficient unoccupied seat locations, program instructions to allocate the additional workspaces to the first component from the unoccupied seat locations owned by the first component; responsive to the first component not owning sufficient unoccupied seat locations, program instructions to execute the actions comprising: program instructions to determine if vacant seats exist in a closest first group owned by a second component; responsive to vacant seats existing, program instructions to allocate the vacant seats to the first component; and responsive to vacant seats not existing, program instructions to calculate if a lower cost is associated with relocating occupied seats associated with the second component to vacant seats in a second group and program instructions to allocate the previously occupied seats to the first component, or program instructions to allocate vacant seats in the second group to the first component, and program instructions to allocate seats based on a lowest cost.

According to an embodiment of the present invention, a computer system for optimizing workspace allocation, the computer system comprising: one or more computer processors; one or more non-transitory computer readable storage media; and program instructions stored on the one or more non-transitory computer readable storage media, the program instructions comprising: program instructions to receive a request, from a first component of an organization, to allocate additional workspaces in a space associated with a floor plan; program instructions to annotate seats in the floor plan as occupied or unoccupied; program instructions to annotate seats in the floor plan based on owning components of the organization; program instructions to annotate non-moveable spaces in the floor plan; program instructions to annotate walkways in the floor plan; program instructions to overlay the floor plan with a grid of predefined cell dimension; program instructions to create groups based on clusters of seat locations; program instructions to annotate the groups based on an owning component with a majority of seats in a group; program instructions to determine if the first component owns sufficient unoccupied seat locations to satisfy the request; responsive to the first component owning sufficient unoccupied seat locations, program instructions to allocate the additional workspaces to the first component from the unoccupied seat locations owned by the first component; responsive to the first component not owning sufficient unoccupied seat locations, program instructions to execute the actions comprising: program instructions to determine if vacant seats exist in a closest first group owned by a second component; responsive to vacant seats existing, program instructions to allocate the vacant seats to the first component; and responsive to vacant seats not existing, program instructions to calculate if a lower cost is associated with relocating occupied seats associated with the second component to vacant seats in a second group and program instructions to allocate the previously occupied seats to the first component, or program instructions to allocate vacant seats in the second group to the first component, and program instructions to allocate seats based on a lowest cost.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 depicts a cloud computing environment, according to embodiments of the present invention.

FIG. 2 depicts abstraction model layers, according to embodiments of the present invention.

FIG. 3 is a high-level architecture, according to embodiments of the present invention.

FIG. 4 is an exemplary detailed architecture, according to embodiments of the present invention.

FIG. 5 is a flowchart of a method, according to embodiments of the present invention.

FIG. 6 is a block diagram of internal and external components of a data processing system in which embodiments described herein may be implemented, according to embodiments of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several embodiments for configuring workspaces by optimizing adjacency based on a knowledge grid. This mechanism can be used as part of a space management application, either communicatively or as an integrated module, to provide the capability to optimize a floorplan based on, at least, defined adjacency requirements with minimal seat location changes. For example, the embodiments described herein can be integrated into the TRIRIGA Suite of space management applications by IBM Corporation.

Embodiments of the present invention can overlay a floorplan with a grid, transform the grid into a table based on reference identifications (IDs), create seating clusters based on connected seats and pathways, create an optimization problem to solve based on the groups in view of defined constraints and optimization functions, transform the grid of clusters into a knowledge grid and apply an algorithm to enforce the constraints while minimizing the number of seat location moves.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

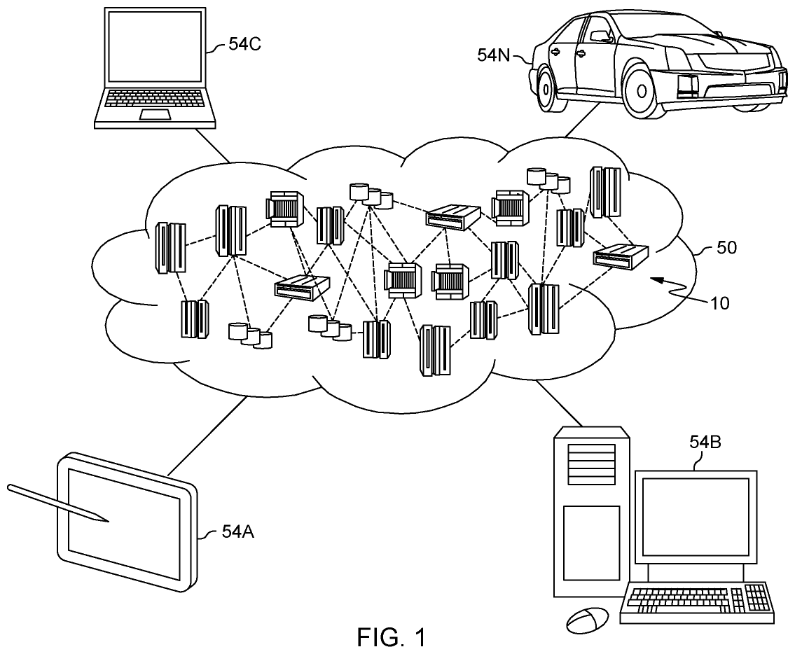

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

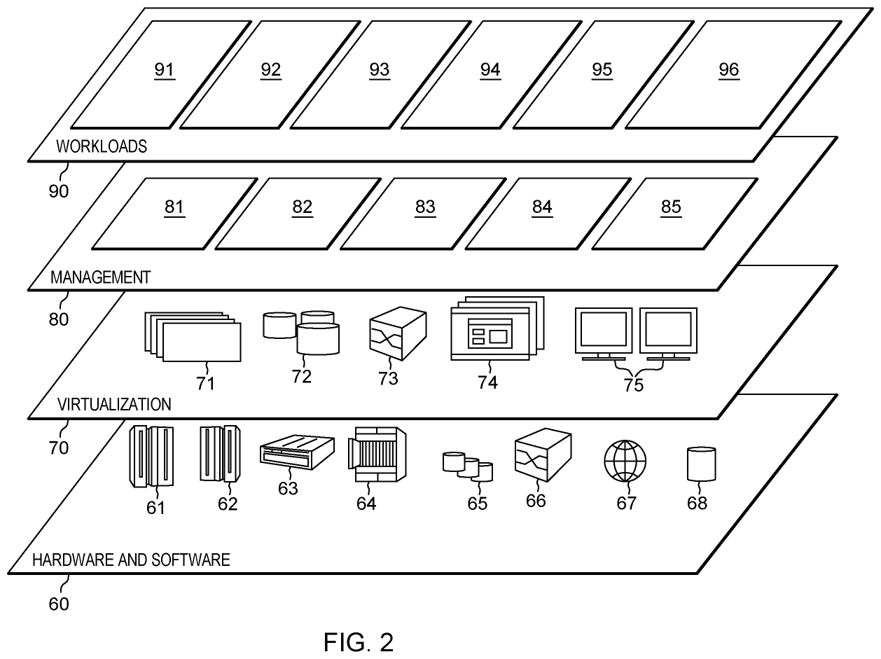

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 include hardware and software components. Examples of hardware components include mainframes 61; RISC (Reduced Instruction Set Computer) architecture-based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include mapping and navigation 91; software development and lifecycle management 92; virtual classroom education delivery 93; data analytics processing 94; transaction processing 95; and workspace optimization management 96.

It should be noted that the embodiments of the present invention may operate with a user's permission. Any data may be gathered, stored, analyzed, etc., with a user's consent. In various configurations, at least some of the embodiments of the present invention are implemented into an opt-in application, plug-in, etc., as would be understood by one having ordinary skill in the art upon reading the present disclosure.

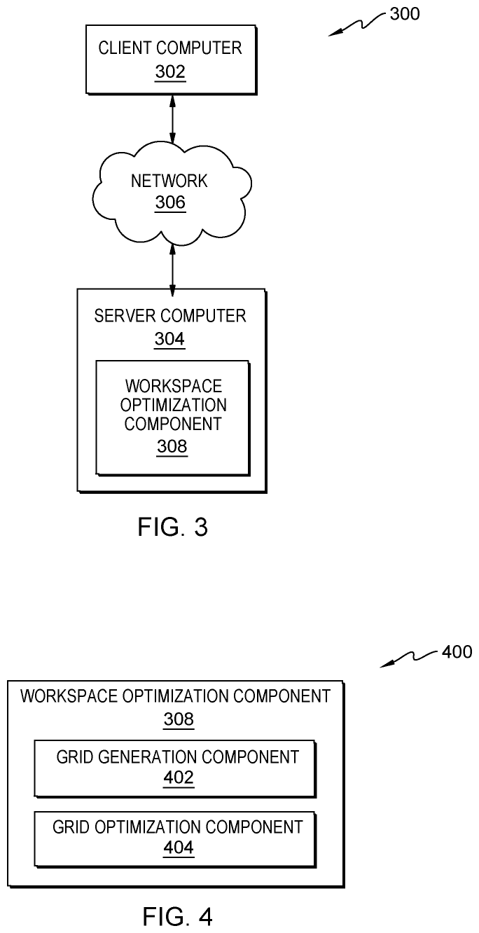

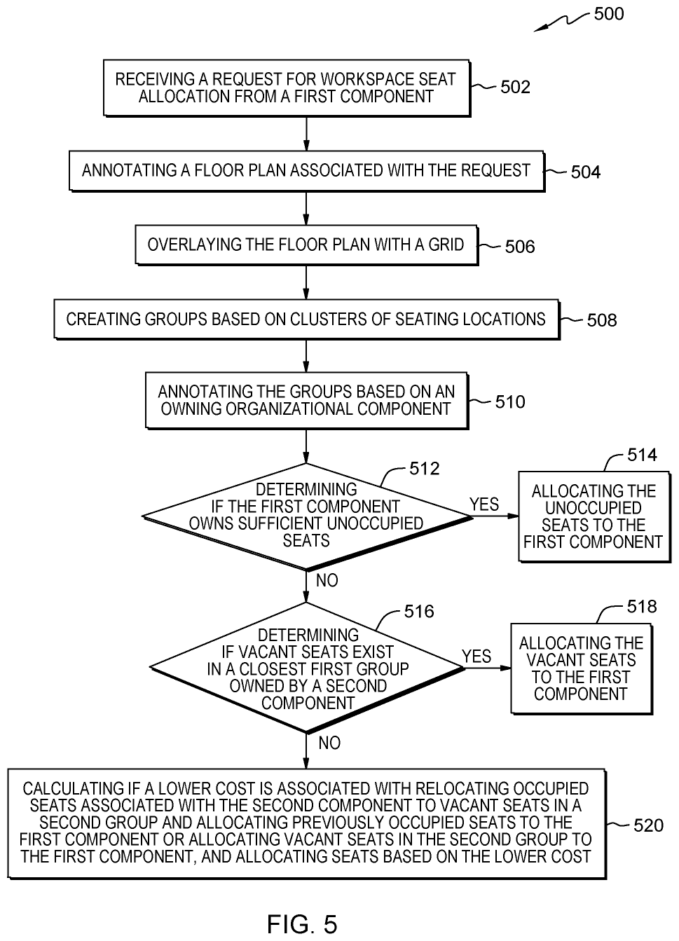

FIG. 3 is a high-level architecture for performing various operations of FIG. 5, in accordance with various embodiments. The architecture 300 may be implemented in accordance with the present invention in any of the environments depicted in FIGS. 1-4, among others, in various embodiments. Of course, more or less elements than those specifically described in FIG. 3 may be included in architecture 300, as would be understood by one of ordinary skill in the art upon reading the present descriptions.

Each of the steps of the method 500 (described in further detail below) may be performed by any suitable component of the architecture 300. A processor, e.g., processing circuit(s), chip(s), and/or module(s) implemented in hardware and/or software, and preferably having at least one hardware component may be utilized in any device to perform one or more steps of the method 500 in the architecture 300. Illustrative processors include, but are not limited to, a central processing unit (CPU), an application specific integrated circuit (ASIC), a field programmable gate array (FPGA), etc., combinations thereof, or any other suitable computing device known in the art.

Architecture 300 includes a block diagram, showing a workspace configuration optimization system, to which the invention principles may be applied. The architecture 300 comprises a client computer 302, an workspace optimization component 308 operational on a server computer 304 and a network 306 supporting communication between the client computer 302 and the server computer 304.

Client computer 302 can be any computing device on which software is installed for which an update is desired or required. Client computer 302 can be a standalone computing device, management server, a web server, a mobile computing device, or any other electronic device or computing system capable of receiving, sending, and processing data. In other embodiments, client computer 302 can represent a server computing system utilizing multiple computers as a server system. In another embodiment, client computer 302 can be a laptop computer, a tablet computer, a netbook computer, a personal computer, a desktop computer or any programmable electronic device capable of communicating with other computing devices (not shown) within user persona generation environment via network 306.

In another embodiment, client computer 302 represents a computing system utilizing clustered computers and components (e.g., database server computers, application server computers, etc.) that act as a single pool of seamless resources when accessed within install-time validation environment of architecture 300. Client computer 302 can include internal and external hardware components, as depicted and described in further detail with respect to FIG. 5.

Server computer 304 can be a standalone computing device, management server, a web server, a mobile computing device, or any other electronic device or computing system capable of receiving, sending, and processing data. In other embodiments, server computer 304 can represent a server computing system utilizing multiple computers as a server system. In another embodiment, server computer 304 can be a laptop computer, a tablet computer, a netbook computer, a personal computer, a desktop computer, or any programmable electronic device capable of communicating with other computing devices (not shown) within install-time validation environment of architecture 300 via network 306.

Network 306 can be, for example, a local area network (LAN), a wide area network (WAN) such as the Internet, or a combination of the two, and can include wired, wireless, or fiber optic connections. In general, network 306 can be any combination of connections and protocols that will support communications between client computer 302 and server computer 304.

In one aspect of an embodiment of the present invention, workspace optimization component 308, operational on server computer 304, can provide the capability to overlay a Floor plan with a grid of cells wherein a cell represents a predefined distance. It should be noted that a distance can be measured in feet, meters, etc.

In another aspect of an embodiment of the present invention, individual cells can represent allocated seating locations assigned by identified owners, e.g., a business unit (BU), as defined by an associated organization. In another aspect of an embodiment, non-movable spaces, e.g., meeting rooms, staircases, breakout-areas, pantry, kitchen, bathroom, etc., can be represented by an indicator such as, but not limited to an “X,” vacant seating locations can be represented by an indicator such as, but not limited to a “V” and passages/walkways can be represented by an indicator such as, but not limited to a “1” depicting a unit distance that can be summed to represent dimensions associated with the floor plan. It should be noted that seating locations can also be identified as non-movable/non-relocatable.

It should be noted that this data can be obtained from computer aided design (CAD) drawings, from floorplan application specifications or by elimination logic, e.g., remaining space after defining occupied workspaces, unoccupied workspaces, and the previously mentioned meeting rooms staircases, break-out areas, pantry, kitchen, bathroom, etc.

FIG. 4 is an exemplary detailed architecture for performing various operations of FIG. 5, in accordance with various embodiments. The architecture 400 may be implemented in accordance with the present invention in any of the environments depicted in FIGS. 1-3 and 5, among others, in various embodiments. Of course, more or less elements than those specifically described in FIG. 4 may be included in architecture 400, as would be understood by one of skill in the art upon reading the present descriptions.

Each of the steps of the method 500 (described in further detail below) may be performed by any suitable component of the architecture 400. A processor, e.g., processing circuit(s), chip(s), and/or module(s) implemented in hardware and/or software, and preferably having at least one hardware component, may be utilized in any device to perform one or more steps of the method 500 in the architecture 400. Illustrative processors include, but are not limited to, a central processing unit (CPU), an application specific integrated circuit (ASIC), a field programmable gate array (FPGA), etc., combinations thereof, or any other suitable computing device known in the art.

Architecture 400 provides a detailed view of at least some of the modules of architecture 300. Architecture 400 can comprise a workspace optimization component 308, which can further comprise grid generation component 402 and grid optimization component 404.

In one aspect of an embodiment of the present invention, grid generation component 402 can present a floor plan in a scalable vector graphics (SVG) format. In another aspect of an embodiment of the present invention, grid generation component 402 can present a floor plan depicting both occupied and unoccupied seating locations. It should be noted that the seating locations throughout the floor plan can be identified by an associated organization identifier, e.g., a business unit, department, team, etc.

In another aspect of an embodiment of the present invention, grid generation component 402 can overlay a floor plan with a grid wherein the size of the cells the grid comprises are a predefined distance of a predefined unit of measure, e.g., feet, meters, etc. In another aspect of an embodiment of the present invention, the grid can be transformed into a table wherein the cells of the table are marked with an organization identifier associated with the occupant of the cell. It should be noted that this indicates both the positions of the seating locations either occupied or unoccupied and the portion of the organization owning/responsible for the seating location.

In one aspect of an embodiment of the present invention, grid generation component 402 can, for example, use letters assigned to the table cells to differentiate organization components owning/occupying the location, the locations relationship to each other and any clustering of locations that can be identified. In another aspect of an embodiment of the present invention, grid generation component 402 can demarcate the seating arrangement associated with the grid into different areas based on the distance between the clusters of seats. It should be noted that unoccupied seats can have an identifier, e.g., “V,” indicating a vacant seating location.

In another aspect of an embodiment of the present invention, grid generation component 402 can mark space non-seating space, previously defined as meeting rooms, staircases, breakout-areas, pantry, kitchen, bathroom, etc. with an indicator, e.g., “X,” and remaining floor space, assumed to be walkways with an indicator, e.g., “1.” It should be noted that distances between seating locations can be defined by arrows showing the distance between a selected seat location and the nearest vacant seat represented in a vector like notation, e.g., [1,1,1,1,1], [1,X,X,X,1] or [1,1,1] for a circumstance wherein there are three paths between the seat location and the nearest vacant seat location.

In another aspect of an embodiment of the present invention, grid generation component 402 can demarcate the seating arrangement associated with the SVG into clusters based on connected seating and identified pathways. For example, an SVG can present eleven clusters in a floor plan based on identified seats and associated pathways. It should be noted that clusters can be assigned to an organization component, e.g., a BU, wherein if a cluster contains a plurality of Bus, then the cluster can be assigned to the BU with the greatest number of seats in the cluster.

In one aspect of an embodiment of the present invention, grid optimization component 404 can frame a desired change to the SVG into an optimization problem based on an objective of minimizing movement of current seating locations while accommodating an organization component, e.g., a BU, request. In another aspect of an embodiment of the present invention, grid optimization component 404 can apply one or more constraints such as, but not limited to, seating locations can be allocated only to seats identified as vacant or otherwise allocatable, existing seating locations can be moved to other allocatable seating locations, the total number of seats associated with the SVG are fixed and other user defined constraints such as, but not limited to, predefined organizational component, e.g., BUs, seating locations cannot be moved, allocated seats must be in the same building, allocated seats must be on the same floor, predefined components cannot occupy adjacent seats and predefined components cannot occupy seats in a same group. It should be noted that a penalty score can be included into the optimization determination based on how far a seat is moved from the seat's original location to discourage moving a seating location too great a distance.

In another aspect of an embodiment of the present invention, grid optimization component 404 can transform a grid with cluster information into a knowledge grid. Grid optimization component 404 can create a knowledge grid to provide initial seat allocation information, cluster information and a group of proximity information of the shortest distances between pairs of clusters.

In another aspect of an embodiment of the present invention, grid optimization component 404 can apply a greedy algorithm to the knowledge grid to solve the optimization problem while including penalties for seat movement to converge on a solution. It should be noted that for each step in the algorithm, a best choice of seat movements is selected based on the least total cost for the movements.

Considering an example, a BU “A” has requested 15 additional seats. Based on the knowledge grid, identify the clusters belonging to “A,” determine if there are 15 vacant seats in the clusters identified as belonging to “A.” It should be noted that a cluster belongs to “A” if “A” has a majority of occupied seats in the cluster. If 15 vacant seats are available in the clusters assigned to “A,” then assign the 15 vacant seats to “A.” If 15 vacant seats are not available in the clusters assigned to “A” then assign the vacant seats in the clusters assigned to “A,” if any, to “A,” subtract the number of assigned seats from the requested seats and proceed to the nearest cluster not assigned to “A.” If the nearest cluster not assigned to “A” has vacant seats, then assign the vacant seats to “A,” subtract the number of assigned seats from the requested seats and determine if occupied seats in the nearest cluster not assigned to “A” should be replaced with the remainder of seat requests by “A” by moving the occupants to the closest cluster with vacant seats or if the remainder of seat requests by “A” should be satisfied by the closest cluster with vacant seats. The determination is made based on a total of an adjacency cost and a movement cost for the circumstance where occupied seats are moved to a closest cluster with vacant seats to make room for a new seat request, compared to an adjacency cost for the circumstance where the new seat request is moved to a closest cluster with vacant seats to satisfy the new seat request. It should be noted that the mechanism described in this example can be repeated until a seat request is satisfied or all available vacant seats are exhausted. It should further be noted that an adjacency cost is calculated based on traversing a shortest walkway distance between seating locations.

FIG. 5 is an exemplary flowchart of a method 500 for optimizing workspace allocation. At step 502, an embodiment can receive, via workspace optimization component 308, a request for workspace seat allocation, associated with a floor plan, from a first component. At step 504, the embodiment can annotate, via grid generation component 402, seats in the floor plan as occupied or unoccupied, organizational owner of seats in the floor plan, non-movable spaces in the floor plan, and walkways in the floorplan. At step 506, the embodiment can overlay, via grid generation component 402, the floor plan with a grid of predefined cell dimension. At step 508, the embodiment can create, via grid generation component 402, seating groups based on clusters of seating locations. At step 510, the embodiment can annotate, via grid generation component 402, the seating groups based on an organizational component possessing the greatest number of seating locations in the seating group. At step 512, the embodiment can determine, via grid optimization component 404, if the requesting organizational component owns sufficient vacant seats to satisfy the request. If step 512 determines the organizational component owns sufficient vacant seats to satisfy the request, then the embodiment proceeds to step 514. At step 514, the embodiment can allocate, via grid optimization component 404, the unoccupied seats to the first component, completing the method. If step 512 determines the organizational component does not own sufficient vacant seats to satisfy the request, then the embodiment proceeds to step 516. At step 516, the embodiment can determine, via grid optimization component 404, if vacant seats exist in a closest first group owned by a second component. If step 516 determines vacant seats exist in a closest first group owned by a second component, then the embodiment proceeds to step 518. At step 518, the embodiment can allocate, via grid optimization component 404, the vacant seats to the first component, completing the method. If step 516 determines vacant seats do not exist in a closest first group owned by a second component, then the embodiment proceeds to step 520. At step 520, the embodiment can calculate, via grid optimization component 404, if a lower cost is associated with relocating occupied seats associated with the second component to vacant seats in a second group and allocating previously occupied seats to the first component or allocating vacant seats in the second group to the first component, and allocating the seats based on the lower cost, completing the method.

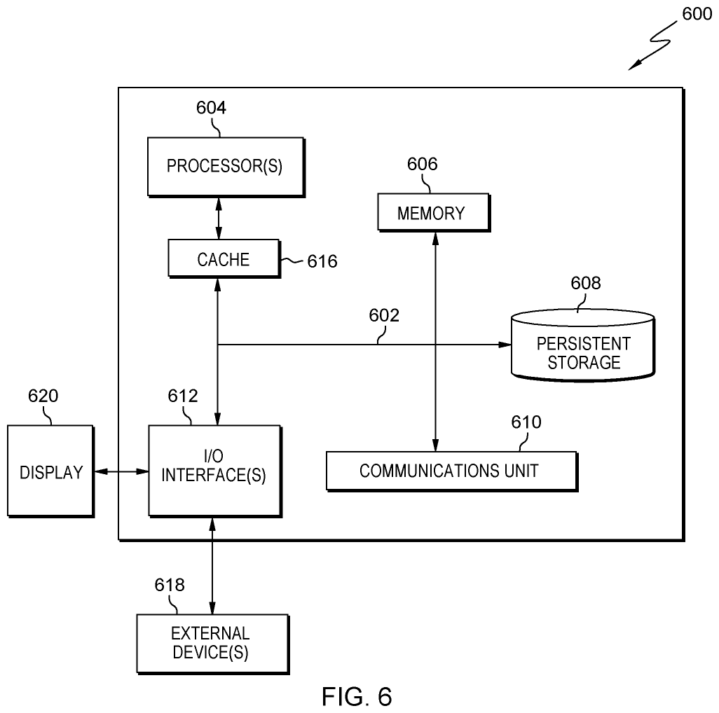

FIG. 6 depicts computer system 600, an example computer system representative of client computer 302 and server computer 304. Computer system 600 includes communications fabric 602, which provides communications between computer processor(s) 604, memory 606, persistent storage 608, communications unit 610, and input/output (I/O) interface(s) 612. Communications fabric 602 can be implemented with any architecture designed for passing data and/or control information between processors (such as microprocessors, communications and network processors, etc.), system memory, peripheral devices, and any other hardware components within a system. For example, communications fabric 602 can be implemented with one or more buses.

Computer system 600 includes processors 604, cache 616, memory 606, persistent storage 608, communications unit 610, input/output (I/O) interface(s) 612 and communications fabric 602. Communications fabric 602 provides communications between cache 616, memory 606, persistent storage 608, communications unit 610, and input/output (I/O) interface(s) 612. Communications fabric 602 can be implemented with any architecture designed for passing data and/or control information between processors (such as microprocessors, communications and network processors, etc.), system memory, peripheral devices, and any other hardware components within a system. For example, communications fabric 602 can be implemented with one or more buses or a crossbar switch.

Memory 606 and persistent storage 608 are computer readable storage media. In this embodiment, memory 606 includes random access memory (RAM). In general, memory 606 can include any suitable volatile or non-volatile computer readable storage media. Cache 616 is a fast memory that enhances the performance of processors 604 by holding recently accessed data, and data near recently accessed data, from memory 606.

Program instructions and data used to practice embodiments of the present invention may be stored in persistent storage 608 and in memory 606 for execution by one or more of the respective processors 604 via cache 616. In an embodiment, persistent storage 608 includes a magnetic hard disk drive. Alternatively, or in addition to a magnetic hard disk drive, persistent storage 608 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 608 may also be removable. For example, a removable hard drive may be used for persistent storage 608. Other examples include optical and magnetic disks, thumb drives, and smart cards that are inserted into a drive for transfer onto another computer readable storage medium that is also part of persistent storage 608.

Communications unit 610, in these examples, provides for communications with other data processing systems or devices. In these examples, communications unit 610 includes one or more network interface cards. Communications unit 610 may provide communications through the use of either or both physical and wireless communications links. Program instructions and data used to practice embodiments of the present invention may be downloaded to persistent storage 608 through communications unit 610.

I/O interface(s) 612 allows for input and output of data with other devices that may be connected to each computer system. For example, I/O interface 612 may provide a connection to external devices 618 such as a keyboard, keypad, a touch screen, and/or some other suitable input device. External devices 618 can also include portable computer readable storage media such as, for example, thumb drives, portable optical or magnetic disks, and memory cards. Software and data used to practice embodiments of the present invention can be stored on such portable computer readable storage media and can be loaded onto persistent storage 608 via I/O interface(s) 612. I/O interface(s) 612 also connect to display 620.

Display 620 provides a mechanism to display data to a user and may be, for example, a computer monitor.

The components described herein are identified based upon the application for which they are implemented in a specific embodiment of the invention. However, it should be appreciated that any particular component nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Moreover, a system according to various embodiments may include a processor and logic integrated with and/or executable by the processor, the logic being configured to perform one or more of the process steps recited herein. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for optimizing workspace allocation, the computer- implemented method comprising:
receiving, by one or more processors, a request, from a first component of an organization, to allocate additional workspaces in a space associated with a floor plan;
annotating, by the one or more processors, seats in the floor plan as occupied or unoccupied;
annotating, by the one or more processors, seats in the floor plan based on owning components of the organization;
annotating, by the one or more processors, non-moveable spaces in the floor plan;
annotating, by the one or more processors, walkways in the floor plan;
overlaying, by the one or more processors, the floor plan with a grid of predefined cell dimension;
creating, by the one or more processors, groups based on clusters of seat locations;
annotating, by the one or more processors, the groups based on an owning component with a majority of seats in a group;
determining, by the one or more processors, if the first component owns sufficient unoccupied seat locations to satisfy the request;
responsive to the first component owning sufficient unoccupied seat locations, allocating, by the one or more processors, the additional workspaces to the first component from the unoccupied seat locations owned by the first component;
responsive to the first component not owning sufficient unoccupied seat locations, executing, by the one or more processors, actions comprising:
determining, by the one or more processors, if vacant seats exist in a closest first group owned by a second component;
responsive to vacant seats existing, allocating, by the one or more processors, the vacant seats to the first component; and
responsive to vacant seats not existing, calculating, by the one or more processors, if a lower cost is associated with relocating occupied seats associated with the second component to vacant seats in a second group and allocating, by the one or more processors, the previously occupied seats to the first component, or allocating, by the one or more processors, vacant seats in the second group to the first component, and allocating, by the one or more processors, seats based on a lowest cost.

2. The computer-implemented method of claim 1, wherein the calculating is based on a greedy algorithm.

3. The computer-implemented method of claim 2, wherein the calculating further comprises:
calculating an adjacency cost based on a count of grid cells between the first component and the vacant seats; and
calculating a movement cost based on a count of grid cells between a relocated seat and a vacant seat.

4. The computer-implemented method of claim 1, wherein one or more occupied seats are marked as not relocatable.

5. The computer-implemented method of claim 1, wherein the additional workspace allocation can be constrained by one or more requirements comprising allocated seats must be in the same building, allocated seats must be on the same floor, predefined components cannot occupy adjacent seats and predefined components cannot occupy seats in a same group.

6. The computer-implemented method of claim 4, wherein the floor plan is a scalable vector graphics format file.

7. The computer-implemented method of claim 3, wherein the adjacency cost is calculated based on traversing a shortest walkway distance.

8. A computer program product for optimizing workspace allocation, the computer program product comprising:
one or more non-transitory computer readable storage media and program instructions stored on the one or more non-transitory computer readable storage media, the program instructions comprising:
program instructions to receive a request, from a first component of an organization, to allocate additional workspaces in a space associated with a floor plan;
program instructions to annotate seats in the floor plan as occupied or unoccupied;
program instructions to annotate seats in the floor plan based on owning components of the organization;
program instructions to annotate non-moveable spaces in the floor plan;
program instructions to annotate walkways in the floor plan;
program instructions to overlay the floor plan with a grid of predefined cell dimension;
program instructions to create groups based on clusters of seat locations;
program instructions to annotate the groups based on an owning component with a majority of seats in a group;
program instructions to determine if the first component owns sufficient unoccupied seat locations to satisfy the request;
responsive to the first component owning sufficient unoccupied seat locations, program instructions to allocate the additional workspaces to the first component from the unoccupied seat locations owned by the first component;
responsive to the first component not owning sufficient unoccupied seat locations, program instructions to execute actions comprising:
program instructions to determine if vacant seats exist in a closest first group owned by a second component;
responsive to vacant seats existing, program instructions to allocate the vacant seats to the first component; and
responsive to vacant seats not existing, program instructions to calculate if a lower cost is associated with relocating occupied seats associated with the second component to vacant seats in a second group and program instructions to allocate the previously occupied seats to the first component, or program instructions to allocate vacant seats in the second group to the first component, and program instructions to allocate seats based on a lowest cost.

9. The computer program product of claim 8, wherein the calculating is based on a greedy algorithm.

10. The computer program product of claim 9, wherein the calculating further comprises:
program instructions to calculate an adjacency cost based on a count of grid cells between the first component and the vacant seats; and
program instructions to calculate a movement cost based on a count of grid cells between a relocated seat and a vacant seat.

11. The computer program product of claim 8, wherein one or more occupied seats are marked as not relocatable.

12. The computer program product of claim 8, wherein the additional workspace allocation can be constrained by one or more requirements comprising allocated seats must be in the same building, allocated seats must be on the same floor, predefined components cannot occupy adjacent seats and predefined components cannot occupy seats in a same group.

13. The computer program product of claim 11, wherein the floor plan is a scalable vector graphics format file.

14. The computer program product of claim 10, wherein the adjacency cost is calculated based on traversing a shortest walkway distance.

15. A computer system for optimizing workspace allocation, the computer system comprising:
one or more computer processors;
one or more non-transitory computer readable storage media; and
program instructions stored on the one or more non-transitory computer readable storage media, the program instructions comprising:
program instructions to receive a request, from a first component of an organization, to allocate additional workspaces in a space associated with a floor plan;
program instructions to annotate seats in the floor plan as occupied or unoccupied;
program instructions to annotate seats in the floor plan based on owning components of the organization;
program instructions to annotate non-moveable spaces in the floor plan;
program instructions to annotate walkways in the floor plan;
program instructions to overlay the floor plan with a grid of predefined cell dimension;
program instructions to create groups based on clusters of seat locations;
program instructions to annotate the groups based on an owning component with a majority of seats in a group;
program instructions to determine if the first component owns sufficient unoccupied seat locations to satisfy the request;
responsive to the first component owning sufficient unoccupied seat locations, program instructions to allocate the additional workspaces to the first component from the unoccupied seat locations owned by the first component;
responsive to the first component not owning sufficient unoccupied seat locations, program instructions to execute actions comprising:
program instructions to determine if vacant seats exist in a closest first group owned by a second component;
responsive to vacant seats existing, program instructions to allocate the vacant seats to the first component; and
responsive to vacant seats not existing, program instructions to calculate if a lower cost is associated with relocating occupied seats associated with the second component to vacant seats in a second group and program instructions to allocate the previously occupied seats to the first component, or program instructions to allocate vacant seats in the second group to the first component, and program instructions to allocate seats based on a lowest cost.

16. The computer system of claim 15, wherein the calculating is based on a greedy algorithm and the floor plan is a scalable vector graphics format file.

17. The computer system of claim 16, wherein the calculating further comprises:
program instructions to calculate an adjacency cost based on a count of grid cells between the first component and the vacant seats; and
program instructions to calculate a movement cost based on a count of grid cells between a relocated seat and a vacant seat.

18. The computer system of claim 15, wherein one or more occupied seats are marked as not relocatable.

19. The computer system of claim 15, wherein the additional workspace allocation can be constrained by one or more requirements comprising allocated seats must be in the same building, allocated seats must be on the same floor, predefined components cannot occupy adjacent seats and predefined components cannot occupy seats in a same group.

20. The computer system of claim 17, wherein the adjacency cost is calculated based on traversing a shortest walkway distance.
